(19) United States
(12) Patent Application Publication
(10) Pub. No.: US 2019/0250322 A1
(43) Pub. Date: Aug. 15, 2019

(54) DISPLAY DEVICE AND METHOD OF MANUFACTURING DISPLAY DEVICE

(71) Applicant: Samsung Display Co., Ltd., Yongin-si (KR)

(72) Inventors: Seong Yong HWANG, Hwaseong-si (KR); Jin Ho PARK, Suwon-si (KR); Seung Beom PARK, Yongin-si (KR); Sung Chan JO, Seoul (KR)

(21) Appl. No.: 16/148,911

(22) Filed: Oct. 1, 2018

(30) Foreign Application Priority Data
Feb. 13, 2018 (KR) 10-2018-0017448

(51) Int. Cl. F21V 8/00

(52) U.S. Cl. CPC G02B 6/0036; G02B 6/0065; G02B 6/005

(57) ABSTRACT

Provided are display device and method of manufacturing a display device. a display device includes: a light guide plate; a low refractive layer disposed on one surface of the light guide plate and having a lower refractive index than a refractive index of the light guide plate; a wavelength conversion layer disposed on the low refractive layer; an optical pattern disposed on the other surface of the light guide plate and including a base film, a first pattern disposed on the base film and having a line shape extending in one direction, and a second pattern formed on a surface of the first pattern; and an adhesive layer disposed between the light guide plate and the base film, wherein the adhesive layer has a refractive index equal to or greater than the refractive index of the light guide plate.

This application claims priority from Korean Patent Application No. 10-2018-0017448, filed on Feb. 13, 2018, in the Korean Intellectual Property Office, the disclosure of which is incorporated herein by reference in its entirety.

### BACKGROUND

### 1. Field of the Invention

The present invention relates to a display device and a method of manufacturing a display device.

### 2. Description of the Related Art

A liquid crystal display device receives light from a backlight assembly and displays an image. The backlight assembly includes a light source and a light guide plate. The light guide plate receives light from the light source and guides a light traveling direction toward a display panel. For the light source, a point light source such as LED is generally used. However, in the case of the point light source, light is diffused and emitted, so that the straightness of light in the light guide plate may become insufficient. When the straightness of light in the light guide plate is damaged, the luminance of a light facing surface may be reduced.

In addition, application of a wavelength conversion film has recently been researched to improve image quality such as color reproducibility of a liquid crystal display device. Generally, a blue light source is used as the light source, and the wavelength conversion film is disposed over the light guide plate to convert blue light into white light. The wavelength conversion film includes wavelength conversion particles. These wavelength conversion particles are protected by a barrier film because they are generally vulnerable to moisture. However, the barrier film is expensive, and may cause an increase in thickness. Further, a complicated assembling process may be required because the wavelength conversion film should be laminated on the light guide plate.

### SUMMARY

Accordingly, an aspect of the present invention is to provide a display device including an optical member having a light guide function with excellent light straightness and/or a wavelength conversion function.

Another aspect of the present invention is to provide a display device which is easy to reuse when defects occur.

Still another aspect of the present invention is to provide a method of manufacturing a display device including an optical member having a light guide function with excellent light straightness and/or a wavelength conversion function.

Still another aspect of the present invention is to provide a method of manufacturing a display device which is easy to reuse when defects occur.

According to an aspect, a display device includes: a light guide plate; a low refractive layer disposed on one surface of the light guide plate and having a lower refractive index than a refractive index of the light guide plate; a wavelength conversion layer disposed on the low refractive layer; an optical pattern disposed on the other surface of the light guide plate and including a base film, a first pattern disposed on the base film and having a line shape extending in one direction, and a second pattern formed on a surface of the first pattern; and an adhesive layer disposed between the light guide plate and the base film, wherein the adhesive layer has a refractive index equal to or greater than the refractive index of the light guide plate.

The light guide plate may be a glass light guide plate, and may have a refractive index of 1.49 to 1.51.

The adhesive layer may have a refractive index of 1.49 to 1.61, and a difference in refractive index between the adhesive layer and the light guide plate may be 0.1 or less.

The optical pattern may have a refractive index equal to or greater than the refractive index of the light guide plate.

The second pattern may have a shape recessed from the surface of the first pattern.

The second pattern may have a width greater than a width of the first pattern.

The first pattern may have a width of 70 μm to 150 μm, and the second pattern may have a width of 130 μm to 180 μm.

The first pattern may include a base portion and a pattern portion disposed on the base portion, the second pattern may include a lower portion and a side wall extending from the lower portion, and a height of the lower portion may be lower than a height of the base portion.

An imaginary horizontal plane parallel to one surface of the light guide plate may be defined, the side wall may form a first angle with the imaginary horizontal plate, and the first angle may be 7.5° to 55°.

The optical pattern may further include a chamfered surface formed at a portion adjacent to one side surface of the light guide plate.

The chamfered surface may form a second angle with an interface of the optical pattern and the adhesive layer, and the second angle may be 1° to 10°.

The low refractive layer may have a refractive index of 1.2 to 1.4.

According to another aspect, a method of manufacturing a display device includes: preparing a light guide plate provided on one surface thereof with a low refractive layer and a wavelength conversion layer; forming a resin layer on one surface of a base film; pressing the resin layer using a stamper to form a pattern portion; forming an adhesive layer on the other surface of the base film and forming a release film on the adhesive layer; and removing the release film and attaching using the adhesive layer the base film to the light guide plate, wherein the adhesive layer has a refractive index equal to or greater than that of the light guide plate.

The stamper may include an engraved pattern and an embossed pattern, and the pattern portion may include a first pattern corresponding to the engraved pattern and a second pattern corresponding to the embossed pattern.

The first pattern may have a lenticular shape, and the second pattern may have a shape recessed from a surface of the first pattern.

The stamper may include an engraved pattern, and the pattern portion may include a first pattern corresponding to the engraved pattern, and the method may further include: forming a second pattern on a surface of the first pattern.

The first pattern may have a lenticular shape, and, forming the second pattern on the surface of the first pattern comprises irradiating the first pattern with a laser to form the second pattern having a shape recessed from the surface of the first pattern.

The forming the adhesive layer and forming the release film on the adhesive layer may be performed before applying the resin layer on one surface of the base film.

The light guide plate may be a glass light guide plate, and may have a refractive index of 1.49 to 1.51.

The adhesive layer may have a refractive index of 1.49 to 1.61, and a difference in refractive index between the adhesive layer and the light guide plate may be 0.1 or less.

However, aspects of the present invention are not restricted to the one set forth herein. The above and other aspects of the present invention will become more apparent to one of ordinary skill in the art to which the present invention pertains by referencing the detailed description of the present invention given below.

### BRIEF DESCRIPTION OF THE DRAWINGS

The above and other aspects and features of the present invention will become more apparent by describing in detail exemplary embodiments thereof with reference to the attached drawings, in which:

FIG. 1 is a perspective view of an optical member according to an embodiment of the present invention;

FIG. 2 is a cross-sectional view taken along the line II-II′ of FIG. 1;

FIG. 3 is a partial perspective view of a display device according to an embodiment;

FIG. 4 is a partial plan view of a display device according to an embodiment;

FIG. 5 is a cross-sectional view taken along the line VII-VII′ of FIG. 4;

FIG. 6 is a cross-sectional view taken along the line VI-VI′ of FIG. 4;

FIG. 7 is a partial cross-sectional view of a display device according to another embodiment of the present invention;

FIG. 8 is a cross-sectional view of a display device according to another embodiment of the present invention;

FIG. 9 is a cross-sectional view of a display device according to an embodiment of the present invention;

FIG. 10 is a cross-sectional view illustrating a method of manufacturing a display device according to an embodiment of the present invention;

FIG. 11 is a cross-sectional view illustrating a method of manufacturing a display device according to an embodiment of the present invention;

FIG. 12 is a cross-sectional view illustrating a method of manufacturing a display device according to an embodiment of the present invention;

FIG. 13 is a cross-sectional view illustrating a method of manufacturing a display device according to an embodiment of the present invention;

FIG. 14 is a cross-sectional view illustrating a method of manufacturing a display device according to an embodiment of the present invention;

FIG. 15 is a cross-sectional view illustrating a method of manufacturing a display device according to an embodiment of the present invention;

FIG. 16 is a cross-sectional view illustrating a method of manufacturing a display device according to an embodiment of the present invention;

FIG. 17 is a cross-sectional view illustrating a method of manufacturing a display device according to an embodiment of the present invention;

FIG. 18 is a cross-sectional view illustrating a method of manufacturing a display device according to an embodiment of the present invention;

FIG. 19 is a cross-sectional view illustrating a method of manufacturing a display device according to an embodiment of the present invention;

FIG. 20 is a cross-sectional view illustrating a method of manufacturing a display device according to an embodiment of the present invention; and

FIG. 21 is a cross-sectional view illustrating a method of manufacturing a display device according to another embodiment of the present invention.

### DETAILED DESCRIPTION OF THE EMBODIMENTS

The advantages and features of the invention and methods for achieving the advantages and features will be apparent by referring to the embodiments to be described in detail with reference to the accompanying drawings. However, the invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the invention is only defined within the scope of the appended claims.

Where an element is described as being related to another element such as being “on” another element or “located on” a different layer or a layer, includes both a case where an element is located directly on another element or a layer and a case where an element is located on another element via another layer or still another element. In contrast, where an element is described as being is related to another element such as being “directly on” another element or “located directly on” a different layer or a layer, indicates a case where an element is located on another element or a layer with no intervening element or layer therebetween. In the entire description of the invention, the same drawing reference numerals are used for the same elements across various figures.

Although the terms “first, second, and so forth” are used to describe diverse constituent elements, such constituent elements are not limited by the terms. The terms are used only to discriminate one constituent element from other constituent elements. Accordingly, in the following description, a first constituent element may be a second constituent element.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the present invention will be described with reference to the attached drawings.

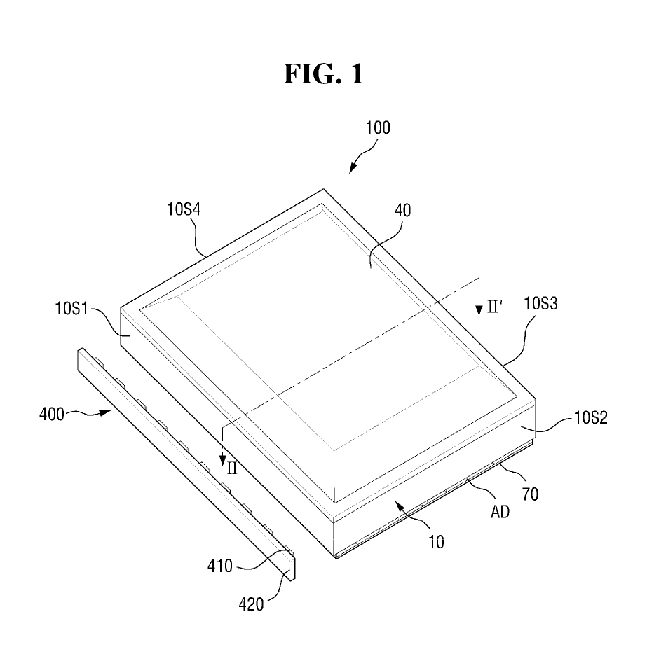

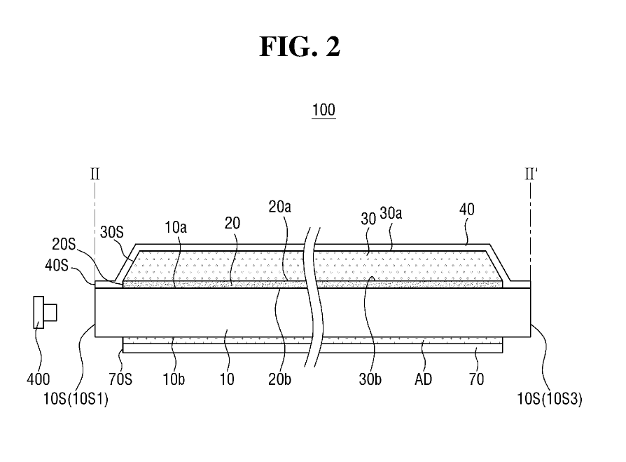

FIG. 1 is a perspective view of an optical member according to an embodiment of the present invention. FIG. 2 is a cross-sectional view taken along the line II-II′ of FIG. 1.

Referring to FIGS. 1 and 2, a display device according to an embodiment of the present invention includes an optical member 100. In an embodiment, the optical member 100 includes a light guide plate 10, a low refractive layer 20 disposed on the upper surface 10a of the light guide plate 10, a wavelength conversion layer 30 disposed on the low refractive layer 20, a passivation layer 40 disposed on the wavelength conversion layer 30, an optical pattern 70 disposed on the lower surface 10b of the light guide plate 10, and an adhesive layer AD disposed between the light guide plate 10 and the optical pattern 70.

The light guide plate 10 serves to guide the traveling path of light. The light guide plate 10 may generally have a polygonal columnar shape. The planar shape of the light guide plate 10 may be rectangular, but is not limited thereto. In an exemplary embodiment, the light guide plate 10 may have a hexagonal columnar shape with a rectangular planar shape, and the hexagonal columnar shape may include an upper surface 10a, a lower surface 10b, and four side surfaces (10S10S: 10S10S1, 10S10S2, 10S10S3, and 10S10S4).

In an embodiment, each of the upper surface 10a and lower surface 10b of the light guide plate 10 is located on one plane. The plane on which the upper surface 10a is located and the plane on which the lower surface 10b is located may be substantially parallel to each other, and thus the light guide plate 10 may have uniform thickness as a whole. However, the present invention is not limited thereto, and the upper surface 10a or the lower surface 10b may be formed of a plurality of planes, or the plane on which the upper surface 10a is located and the plane on which the lower surface 10b is located may intersect each other. For example, in a wedge-typed light guide plate 10, the thickness thereof may become thinner from one side surface (for example, light incidence surface) to the other side surface (for example, light facing surface) facing the one side surface. Further, in the vicinity of one side surface (for example, light incidence surface), the lower surface 10b is inclined upward toward the other side surface (for example, light facing surface) facing the one side surface to reduce the thickness thereof, and then the upper surface 10a and the lower surface 10b may be formed in a flat shape.

In an example, the light source 400 may be disposed adjacent to at least one side surface 10S10S of the light guide plate 10. FIG. 1 illustrates a case where a plurality of LED light sources 410 mounted on a printed circuit board 420 are disposed adjacent to one side surface 10S10S1 at which one long side of the light guide plate 10 is located, but the present invention is limited thereto. For example, the plurality of LED light sources 410 may be disposed adjacent to both long side surfaces 10S10S1 and 10S10S3, or may be disposed adjacent to one short side surface 10S10S2 or 10S10S4 or both short side surfaces 10S10S2 and 10S4. In the embodiment of FIG. 1, one long side surface 10S10S1 of the light guide plate 10 disposed adjacent to the light source 400 is a light incidence surface (marked as ‘10S10S 1’ for convenience of explanation in the drawings), and the other long side surface 10S10S3 facing the one long side surface is a light facing surface (marked as ‘10S10S3’ for convenience of explanation in the drawings).

In an embodiment, the light guide plate 10 may be a glass light guide plate made of glass. In this case, the refractive index of the light guide plate 10 may be 1.49 to 1.51.

In another embodiment, the light guide plate 10 may be made of an organic material or an inorganic material. For example, the light guide plate 10 may be made of an organic material such as PMMA (polymethyl methacrylate), PC, or PET, or an inorganic material such as glass, but the present invention is not limited thereto.

The low refractive layer 20 is disposed on the upper surface 10a of the light guide plate. The low refractive layer 20 is interposed between the light guide plate 10 and the wavelength conversion layer 30 to help in esuring total reflection of the light guide plate 10. More specifically, in order for the light guide plate 10 to perform efficient light guide from the light incidence surface 10S1 to the light facing surface 10S3, it is preferable that effective total internal reflection is performed on the upper surface 10a and lower surface 10b of the light guide plate 10. One of the conditions under which total internal reflection can be performed in the light guide plate 10 is that the refractive index of the light guide plate 10 is larger than the refractive index of a medium forming an optical interface together with the light guide plate 10. As the refractive index of the medium forming the optical interface together with the light guide plate 10 becomes lower, a total reflection critical angle becomes smaller, so that more total internal reflections can be performed.

In the case where the light guide plate 10 is made of glass, when the upper surface 10a of the light guide plate 10 is exposed to an air layer to form an interface therebetween, sufficient total reflection may be performed because the air layer generally has a refractive index of about 1. However, as shown in FIG. 2, when other optical functional layers are integrally laminated on the upper surface 10a of the light guide plate 10, generally, it is difficult to obtain sufficient total reflection. For example, when a material layer having a refractive index of 1.5 or more is laminated on the upper surface 10a of the light guide plate 10, total reflection cannot be performed on the upper surface 10a of the light guide plate 10. Further, when a material layer having a refractive index slightly smaller than that of the light guide plate 10, for example, about 1.49, is laminated on the upper surface 10a of the light guide plate 10, total internal reflection can be performed on the upper surface 10a of the light guide plate 10, but sufficient total internal reflection cannot be performed because a critical angel is too large. The wavelength conversion layer 30 laminated over the upper surface 10a of the light guide plate 10 generally has a refractive index of about 1.5. When this wavelength conversion layer 30 is directly laminated on the upper surface 10a of the light guide plate 10, it is difficult to obtain sufficient total reflection on the upper surface 10a of the light guide plate 10.

The low refractive layer 20 interposed between the light guide plate 10 and the wavelength conversion layer 30 to form a interface together with the upper surface 10a of the light guide plate 10 has a lower refractive index than the light guide plate 10, so as to allow total reflection to be performed on the upper surface 10a of the light guide plate 10. Further, the low refractive layer 20 has a lower refractive index than the wavelength conversion layer 30, which is a material layer disposed thereon, so as to allow more total reflections to be performed compared to when the wavelength conversion layer 30 is directly disposed on the upper surface 10a of the light guide plate 10.

The difference in refractive index between the light guide plate 10 and the low refractive layer 20 may be 0.2 or more. When the refractive index of the low refractive layer 20 is smaller than the refraction index of the light guide plate 10 by 0.2 or more, sufficient total reflection can be performed through the upper surface 10a of the light guide plate 10. The upper limit of the difference in refractive index between the light guide plate 10 and the low refractive layer 20 is not particularly limited, but may be 1 or less in consideration of the refractive indexes of the commonly-used light guide plate 10 and low refractive index layer 20.

The refractive index of the low refractive layer 20 may be in a range of 1.2 to 1.4. Generally, the closer the refractive index of a solid medium is to 1, the more exponentially the manufacturing cost thereof increases. When the refractive index of the low refractive layer 20 is 1.2 or more, an excessive increase in manufacturing cost can be prevented. Further, when the refractive index of the low refractive layer 20 is 1.4 or less, it is advantageous to sufficiently reduce the total reflection critical angle of the upper surface 10a of the light guide plate 10. In an exemplary embodiment, a low refractive layer 20 having a refractive index of about 1.25 may be applied.

The low refractive layer 20 may include voids to exhibit the above-mentioned low refractive index. The voids may be formed in a vacuum, or may be filled with an air layer, gas, or the like. The void space may be defined by particles, matrices, or the like.

The thickness of the low refractive layer 20 may be 0.4 μm to 2 μm. When the thickness of the low refractive layer 20 is 0.4 μm or more in the visible light wavelength range, an effective optical interface can be formed together with the upper surface of the light guide plate 10, so that the total reflection according to Snell's law can be performed well on the upper surface of the light guide plate 10. When the low refractive index layer 20 is too thick, it run against the thinning of the optical member 100, a material cost increases, and the thickness of the low refractive index layer 20 is disadvantageous in the luminance of the optical member 100, so that the low refractive layer 20 may be formed to have a thickness of 2 μm or less. In an exemplary embodiment, the thickness of the low refractive layer 20 may be about 0.5 μm.

The low refractive layer 20 covers most of the upper surface 10a of the light guide plate 10, and may expose a part of the edge of the light guide plate 10. In other words, the side surface 10S of the light guide plate 10 may protrude with respect to the side surface 20s of the low refractive layer 20. The upper surface 10a of the light guide plate 10 to which the low refractive layer 20 is exposed provides a space in which the side surface 20s of the low refractive layer 20 can be stably covered by the passivation layer 40.

The low refractive layer 20 may be formed by a method such as coating. For example, the low refractive layer 20 may be formed by applying a composition for the low refractive layer 20 onto the upper surface of the light guide plate 10 by slit coating and then drying and curing the composition. However, the present invention is not limited thereto, and other various lamination methods may be used.

The wavelength conversion layer 30 is disposed on the upper surface of the low refractive layer 20. The wavelength conversion layer 30 converts the wavelength of at least a part of incident light. The wavelength conversion layer 30 may include a binder layer and wavelength conversion particles dispersed in the binder layer. The wavelength conversion layer 30 may further include scattering particles dispersed in the binder layer in addition to the wavelength conversion particles.

The binder layer is a medium in which the wavelength converting particles are dispersed, and may be made of various resin compositions which may be generally referred to as a binder. However, the present invention is not limited thereto. In this specification, the medium may be referred to as a binder layer regardless of its name, other additional functions, constituent materials, and the like, as long as it can disperse the wave conversion particles and/or the scattering particles.

The wavelength conversion particles are particles for converting the wavelength of incident light, and may be, for example, quantum dots (QD), fluorescent material particles, or phosphorescent material particles. Specifically using the quantum dots as an example of the wavelength converting particles, the quantum dot is a material having a crystal structure of several nanometers, is composed of several hundreds to several thousands of atoms, and exhibits a quantum confinement effect of increasing an energy bandgap due to a small size. When light having a wavelength higher than the energy bandgap of the quantum dot is applied, the quantum dot absorbs the light to be in an excited state, and emits light having a specific wavelength to fall to a ground state. The wavelength of the emitted light has a value corresponding to the energy bandgap. The quantum dots can control the luminescence characteristics due to the quantum confinement effect by adjusting the size and composition thereof.

The wavelength converting particles may include a plurality of wavelength converting particles for converting incident light to different wavelengths. For example, the wavelength conversion particle may include a first wavelength conversion particle converting incident light of a specific wavelength into light of a first wavelength and emits the light and a second wavelength conversion particle converting incident light of a specific wavelength into light of a second wavelength and emits the light. In an exemplary embodiment, the light emitted from the light source and incident on the wavelength conversion particle is blue light, the first wavelength may be a green wavelength, and the second wavelength may be a red wavelength. For example, the blue wavelength is a wavelength having a peak at 420 to 470 nm, the green wavelength is a wavelength having a peak at 520 nm to 570 nm, and the red wavelength may be a wavelength having a peak at 620 nm to 670 nm. However, it should be understood that the blue, green, and red wavelengths are not limited to the above examples, and include all wavelength ranges that can be recognized as blue, green, and red in the art.

In the above exemplary embodiment, the blue light incident on the wavelength conversion layer 30 passes through the wavelength conversion layer 30 and simultaneously a part of the blue light enters the first wavelength conversion particles to be converted into a green wavelength and emitted, another part of the blue light enters the second wavelength conversion particles to be converted into a red wavelength and emitted, and a residual part of the blue light is directly emitted without encountering the first and second wavelength conversion particles. Therefore, the light having passed through the wavelength conversion layer 30 includes all light of a blue wavelength, light of a green wavelength, and light of a red wavelength. When the ratio of the emitted light of different wavelengths is appropriately adjusted, white light or outgoing light of other colors can be displayed. The converted lights in the wavelength conversion layer 30 are concentrated within a narrow range of specific wavelengths, and have a sharp spectrum with a narrow half width. Therefore, when colors are expressed by filtering the light of such a spectrum with a color filter, color reproducibility can be improved.

In another embodiment, incident light is short-wavelength light such as ultraviolet light, and three kinds of wavelength conversion particles for converting the incident light into light of blue, green and red wavelengths are disposed in the wavelength conversion layer 30, so as to emit white light.

The wavelength conversion layer 30 may further include scattering particles. The scattering particles may be non-quantum particles, and may also be particles having no wavelength conversion function. The scattering particles can scatter incident light such that more incident light can be incident onto the wavelength conversion particles. In addition, the scattering particles can serve to uniformly control the emission angle of light for each wavelength. Specifically, when a part of incident light is incident on the wavelength conversion particles to convert a wavelength of the light and then the light of the converted wavelength is emitted, the light can have scattering characteristics of a random emission direction. If the scattering particles are not present in the wavelength conversion layer 30, the light of green and red wavelengths emitted after the collision with the wavelength conversion particles has scattering emission characteristics, but the light of a blue wavelength emitted without the collision with the wavelength conversion particles does not have scattering emission characteristics, so that the emission amount of the light of blue/green/red wavelengths will be different depending on the emission angle. The scattering particles provides scattering emission characteristics to the light of a blue wavelength emitted without the collision with the wavelength conversion particles, thereby similarly adjusting the emission angle of light for each wavelength. As the scattering particles, TiO₂, SiO₂, or the like may be used.

The wavelength conversion layer 30 may be thicker than the low refractive layer 20. The thickness of the wavelength conversion layer 30 may be about 10 μm to 50 μm. In an exemplary embodiment, the thickness of the wavelength conversion layer 30 may be at 15 μm.

The wavelength conversion layer 30 may cover the upper surface 20a of the low refractive index layer 20, and may completely overlap the low refractive index layer 20. The lower surface 30b of the wavelength conversion layer 30 may be in direct contact with the upper surface 20a of the low refractive layer 20. In an embodiment, the side surface 30s of the wavelength conversion layer 30 may be aligned with the side surface 20s of the low refractive layer 20. The inclination angle of the side surface 30s of the wavelength conversion layer 30 may be smaller than the inclination angle of the side surface 20s of the low refractive layer 20. As described later, when the wavelength conversion layer 30 is formed by slit coating or the like, the side surface 30s of the relatively thick wavelength conversion layer 30 may have a gentle inclination angle smaller than the side surface 20s of the low refractive layer 20. However, the present invention is not limited thereto, and the inclination angle of the side surface 30s of the wavelength conversion layer 30 may be substantially equal to or smaller than the inclination angle of the side surface 20s of the low refractive index layer 20 depending on the forming method.

The wavelength conversion layer 30 may be formed by a method such as coating. For example, the wavelength conversion layer 30 may be formed by applying a wavelength conversion composition onto the light guide plate 10 provided with the low refractive layer 20 and then drying and curing the composition. However, the present invention is not limited thereto, and various other lamination methods may be used.

The passivation layer 40 is disposed on the low refractive layer 20 and the wavelength conversion layer 30. The passivation layer 40 serves to prevent the permeation of moisture and/or oxygen (hereinafter, referred to as “moisture/oxygen”). The passivation layer 40 may contain an inorganic material. For example, the passivation layer 40 may contain silicon nitride, aluminum nitride, zirconium nitride, titanium nitride, hafnium nitride, tantalum nitride, silicon oxide, aluminum oxide, titanium oxide, tin oxide, cerium oxide, or silicon oxynitride, or may be a metal thin film having light transmittance. In an exemplary embodiment, the passivation layer 40 may be made of silicon nitride.

The passivation layer 40 completely covers the low refractive index layer 20 and the wavelength conversion layer 30. The passivation layer 40 completely overlaps the wavelength conversion layer 30 and extends further outwardly therefrom to cover the side surface 30s of the wavelength conversion layer 30 and the side surface 20s of the low refractive layer 20. The passivation layer 40 extends to the upper surface 10a of the edge of the light guide plate 10 exposed by the low refractive layer 20 such that a part of the edge of the passivation layer 40 is in direct contact with the upper surface 10a of the light guide plate 10. In an embodiment, the side surface 40s of the passivation layer 40 may be aligned with the side surface 10S of the light guide plate 10. The inclination angle of the side surface 40s of the passivation layer 40 may be larger than the inclination angle of the side surface 30s of the wavelength conversion layer 30. Further, the inclination angle of the side surface 40s of the passivation layer 40 may be larger than the inclination angle of the side surface 20s of the low refractive layer 20.

The thickness of the passivation layer 40 may be smaller than that of the wavelength conversion layer 30, and may be similar to or smaller than that of the low refractive layer 20. The thickness of the passivation layer 40 may be 0.1 μm to 2 μm. When the thickness of the passivation layer 40 is 0.1 μm or more, the passivation layer can exhibit a significant moisture/oxygen permeation preventing function, and when the thickness thereof is 0.3 μm or more, the passivation layer can have an effective significant moisture/oxygen permeation preventing function. The passivation layer 40 having a thickness of 2 μm or less is advantageous in terms of thinning and transmittance. In an exemplary embodiment, the thickness of the passivation layer 40 may be about 0.4 μm.

The wavelength conversion layer 30, particularly, the wavelength conversion particles included therein, is vulnerable to moisture/oxygen. In the case of a wavelength conversion film, barrier films are laminated on the upper and lower surfaces of the wavelength conversion layer 30 to prevent the permeation of moisture/oxygen. In contrast, in the case of this embodiment, the wavelength conversion layer 30 is directly disposed without a barrier film, so that a sealing structure for protecting the wavelength conversion layer 30 is required instead of the barrier film. The sealing structure may be realized by the passivation layer 40 and the light guide plate 10.

The gate through which moisture can permeate the wavelength conversion layer 30 is the upper surface 30a, side surface 30s, and lower surface 30b of the wavelength conversion layer 30. As described above, since the upper surface 30a and side surface 30s of the wavelength conversion layer 30 are covered and protected by the passivation layer 40, the permeation of moisture/oxygen can be blocked or at least reduced (hereinafter referred to as “blocked/reduced”).

Meanwhile, the lower surface 30b of the wavelength conversion layer 30 is in contact with the upper surface 20a of the low refractive layer 20. In this case, when the low refractive layer 20 includes voids or is made of an organic material, moisture can move in the low refractive layer 20, so that the permeation of moisture/oxygen into the lower surface 30b of the wavelength conversion layer 30 can be conducted. However, since the side surface 20s of the low refractive layer 20 is covered and protected by the passivation layer 40, the permeation of moisture/oxygen through the side surface 20s of the low refractive layer 20 can be blocked/reduced. Even when the low refractive layer 20 protrudes from the wavelength conversion layer 30 to allow a part of the upper surface 20a thereof to be exposed, the corresponding portion is covered and protected by the passivation layer 40, so that the permeation of moisture/oxygen can be blocked/reduced. The lower surface 20b of the low refractive layer 20 is in contact with the light guide plate 10. When the light guide plate 10 is made of an inorganic material such as glass, the permeation of moisture/oxygen can be blocked/reduced in the same manner as the passivation layer 40. Consequently, since the surface of the laminate of the low refractive layer 20 and the wavelength conversion layer 30 is surrounded and sealed by the passivation layer 40 and the light guide plate 10, even when the transfer path of moisture/oxygen is provided in the low refractive layer 20, the moisture/oxygen permeation itself can be blocked/reduced by the sealing structure, so that the deterioration of the wavelength conversion particles caused by moisture/oxygen can be prevented or at least alleviated.

The passivation layer 40 may be formed by a method such as vapor deposition. For example, the passivation layer 40 may be formed on the light guide plate 10, on which the low refractive layer 20 and the wavelength conversion layer 30 are sequentially formed, by using chemical vapor deposition. However, the present invention is not limited thereto, and various other lamination methods may be used.

In addition, the wavelength conversion layer 30 of the optical member 100 and the sealing structure thereof can reduce a manufacturing cost and thickness, compared with a conventional wavelength converting film provided as a separate film. Specifically, the conventional wavelength conversion film is configured such that barrier films are attached to the upper and lower surfaces of the wavelength conversion layer 30. In this case, the barrier film is expensive, and is thick to have a thickness of 100 μm or more, so that the total thickness of the wavelength conversion film is about 270 μm. In contrast, since the optical member according to embodiments of the present disclosure is formed of the low refractive layer 20 having a thickness of about 0.5 μm and the passivation layer having a thickness of about 0.4 μm, the total thickness of the optical member 100 excluding the light guide plate 10 can be maintained at a level of about 16 μm, so that the thickness of the display device employing the optical member 100 can be reduced. Further, since the optical member according to embodiments is not provided with an expensive barrier film, a manufacturing cost can be controlled at a lower level than that of the conventional wavelength conversion film.

Subsequently, the optical pattern 70 will be described in detail.

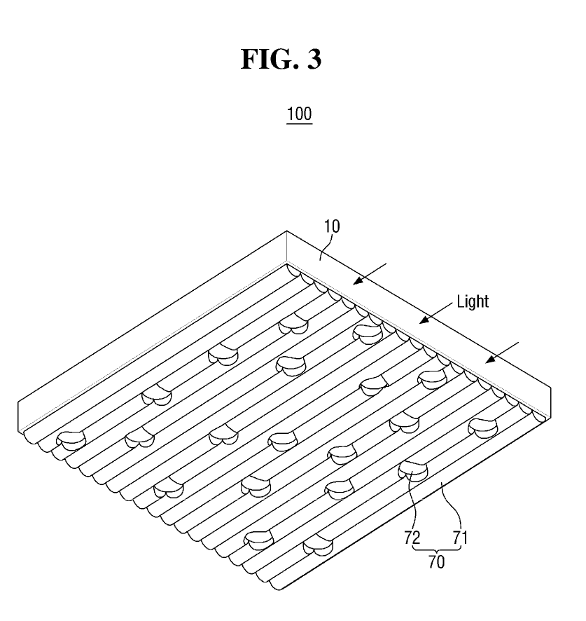

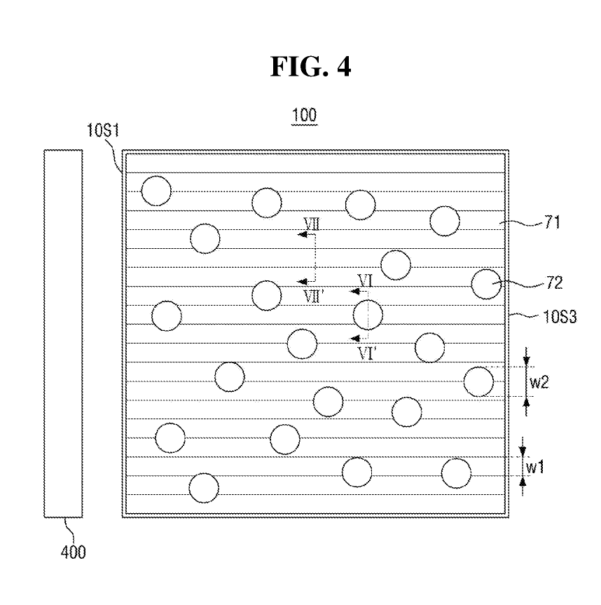

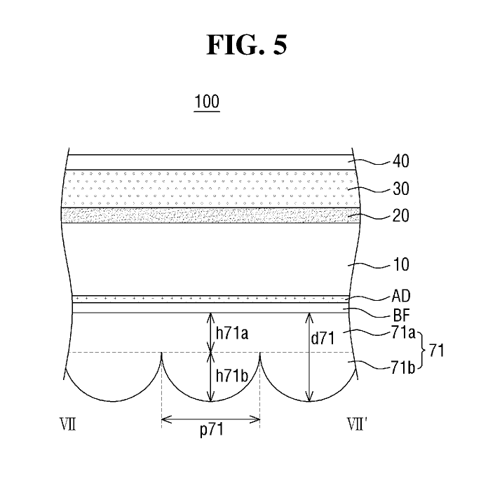

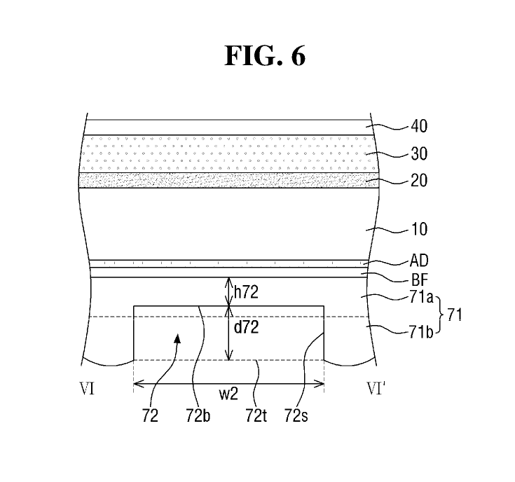

FIG. 3 is a partial perspective view of a display device according to an embodiment. FIG. 4 is a partial plan view of a display device according to an embodiment. FIG. 5 is a cross-sectional view taken along the line VII-VII′ of FIG. 4. FIG. 6 is a cross-sectional view taken along the line VI-VI′ of FIG. 4.

Referring to FIG. 2, the optical pattern 70 is disposed on the lower surface 10b of the light guide plate 10. The optical pattern 70 adjusts the traveling path of light to allow the light guide plate 10 to uniformly supply the light toward the display panel. The optical pattern 70 covers most of the lower surface 10b of the light guide plate 10, and may expose a part of the edge of the light guide plate 10. In other words, the side surface 10S of the light guide plate 10 may protrude with respect to the side surface 70s of the optical pattern 70. It is possible to prevent the optical pattern 70 from protruding outward beyond the light guide plate 10 by securing a certain space between the side surface 70s of the optical pattern 70 and the side surface 10S of the light guide plate 10. Further, in the case of forming the optical pattern 70 using an imprinting method, it is possible to prevent a resin from overflowing toward the side face 10S of the light guide plate 10 during a resin application process.

The side surface 70s of the optical pattern 70 may be substantially aligned with the side surface 20s of the low refractive layer 20.

In an embodiment, the optical pattern 70 may be made of a material having a refractive index equal to or greater than that of the light guide plate 10. For example, in an embodiment in which the light guide plate 10 is made of glass, the refractive index of the optical pattern 70 may be 1.49 to 1.61.

When the refractive index of the optical pattern 70 is equal to the refractive index of the light guide plate 10, light may be traveled as a single integrated light guide plate without recognizing the interface between the lower surface 10b of the light guide plate 10 and the optical pattern 70 as an optical interface. However, the present invention is not limited thereto, and the optical pattern 70 may have a refractive index greater than that of the light guide plate 10. In this case, refraction and reflection can be performed at the interface, but the overall light guide function can be maintained.

In an embodiment, the adhesive layer AD may be disposed between the optical pattern 70 and the light guide plate 10.

The adhesive layer AD may serve to attach the optical pattern 70 to the light guide plate 10.

In an embodiment, the thickness of the adhesive layer AD may be 5 μm to 20 μm. When the thickness of the adhesive layer AD is less than 5 μm, adhesive performance may be lowered, and thus it may be difficult to secure a sufficient adhesive force. When the thickness thereof is more than 20 μm, the overall optical properties may deteriorate.

When light travelling toward the lower surface 10b of the light guide plate 10 is reflected by the adhesive layer AD, the optical pattern 70 cannot perform its own function. Therefore, the refractive index of the adhesive layer AD may be equal to or greater than that of the light guide plate 10 such that total reflection does not occur at the interface between the adhesive layer AD and the light guide plate 10.

In other words, in an embodiment, the difference in refractive index between the adhesive layer AD and the light guide plate 10 may be 0 to 0.1. Even when the refractive index of the light guide plate 10 is equal to that of the adhesive layer AD, total reflection does not occur.

That is, the refractive index of the adhesive layer AD may be 1.49 to 1.61.

When the optical pattern 70 and the light guide plate 10 are attached to each other by the adhesive layer AD, there is an advantage that another structure in a normal state can be reused by removing any one of the optical pattern 70 and the light guide plate 10 when a defect occurs in the optical pattern 70 or the light guide plate 10. For example, when the optical pattern 70 is defective, the optical pattern 70 may be easily removed from the light guide plate 10, and then a new optical pattern 70 may be attached to the existing light guide plate 10.

Referring to FIGS. 3-6, the optical pattern 70 will be described in more detail. In an embodiment, the optical pattern 70 may include a base film BF, a first pattern 71, and a second pattern 72.

The base film BF may provide a space in which the first pattern 71 and the second pattern 72 to be described later are disposed. One side of the base film BF may be in direct contact with the adhesive layer AD, and thus the optical pattern 70 and the light guide plate 10 may be attached together.

In an embodiment, the base film BF may include at least one selected from the group consisting of acrylate, polymethyl methacrylate (PMMA), polycarbonate (PC), cycloolefin polymer (COP), and methacrylate styrene (MS). However, this is an example, and the material of the base film BF is not limited thereto. Further, in an embodiment, the thickness of the base film BF may be 60 μm to 80 μm.

The refractive index of the base film BF may be equal to or greater than that of the light guide plate 10. For this, the refractive index of the base film BF may be 1.49 to 1.61.

The first pattern 71 may be disposed on the base film BF. Referring to FIGS. 3 and 4, the first pattern 71 includes a convex surface, has a continuous line shape extending from the light incidence surface 10S1 to the light facing surface 10S3, and guides the light incident into the light guide plate 10 to be straightly traveled toward the light facing surface 10S3. That is, the first pattern 71 refracts light traveling toward both side surfaces 10S2 and 10S4 adjacent to the light facing surface 10S3 to allow the refracted light to travel toward the light facing surface 10S3.

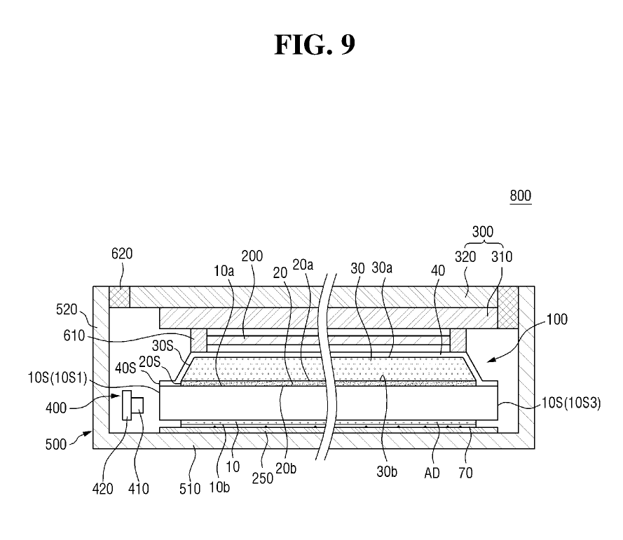

The second pattern 72 has a groove shape formed on the first pattern 71, and refracts light to guide the travelling direction of the light toward the display panel, such as the display panel 300 in FIG. 9 to be described below. That is, the second pattern 72 refracts the light traveling through the total reflection in the light guide plate 10 and the optical pattern 70 to allow the light to travel toward the display panel 300.

In an embodiment, the refractive index of the first pattern 71 and the second pattern 72 may be 1.49 to 1.61.

When the refractive index of the light guide plate 10 is 1.49 to 1.51 and the refractive index of the adhesive layer AD and the optical pattern 70 is maintained to be equal to or greater than the refractive index of the light guide plate 10 in the range of 1.49 to 1.61 as described above, the light emission rate of the optical member 100 can be improved.

Referring to FIG. 5, in an embodiment, the first pattern 71 may include a base portion 71a and a pattern portion 71b.

The base portion 71a may be disposed between the base film BF and the pattern portion 71b, and may be defined as a portion where no pattern is formed.

The base portion 71a supports the pattern portion 71b such that the first pattern 71 can be sufficiently attached to the light guide plate 10.

The pattern portion 71b means a portion where the pattern is formed. The pattern portion 71b may adjust the path of light. That is, the path of light is adjusted such that the light entering the light incidence surface 10S1 passes through the base portion 71a, and is refracted/reflected at the interface formed by the pattern portion 71b and an air layer to travel toward the light facing surface 10S3. Specifically, a part of light emitted from the light source 400 travels toward the light facing surface 10S3, and another part of the light travels toward both side surfaces 10S2 and 10S4 between the light facing surface 10S3 and the light incidence surface 10S1. The traveling direction of the light may be changed such that a part of the light traveling toward both side surfaces 10S2 and 10S4 is refracted at the interface between the pattern portion 71b and the air layer to travel toward the light facing surface 10S3.

The pattern portion 71b may have a straight line shape extending continuously from the light incidence surface 10S1 to the light facing surface 10S3. In an embodiment, the pattern portion 71b may have any one sectional shape selected from a semicircle, a triangle, and a rectangle. The sectional shape of the pattern portion 71b may be constant along the extended straight line, but the present invention is not limited thereto. For example, the pattern portion 71b may have a lenticular shape as shown in FIG. 4, and may have a semi-circular section whose size is constant from the light incidence surface 10S1 to the light facing surface 10S3. Although not shown in the drawing, the semi-circular section of the pattern portion 71b may become larger in size from the light incidence surface 10S1 to the light facing surface 10S3.

The thickness d71 of the first pattern 71 can be calculated as the sum of the height h71a of the base portion 71a and the height h71b of the pattern portion 71b. The base portion 71a has the same height h71a throughout the first pattern 71, whereas the height h71b of the pattern 71b may vary depending on the shape of the pattern. Therefore, the change of the thickness d71 of the first pattern 71 depends on the change of the height h71b of the pattern portion 71b. Illustratively, when the first pattern 71 is a lenticular pattern, a position where the thickness d71 of the first pattern 71 is largest may correspond to a position where the height h71b of the pattern portion 71b is highest, that is, a ridge. Further, a position where the thickness d71 of the first pattern 71 is smallest may correspond to a valley. At the valley, the thickness d71 of the first pattern 71 may be equal to the height h71a of the base portion 71a.

The maximum value of the thickness d71 of the first pattern 71 may be about 40 μm or less. When the thickness d71 of the first pattern 71 is more than 40 μm, it goes against the thinning of the optical member 100, a material cost increases, and a possibility of the first pattern being detached from the light guide plate 10 with the increase in weight may increase. In addition, when the first pattern 71 is formed by an imprinting method, UV curing time increases according to the increase of the thickness of the applied resin, so that a possibility of the first pattern 71 becoming yellow increases. Although the lower limit of the thickness d71 of the first pattern 71 is not limited, it is preferable that the base portion 71a and the pattern portion 71b have enough thickness to exhibit a sufficient effect.

The height h71a of the base portion 71a and the height h71b of the pattern portion 71b may be determined in consideration of the thickness d71 of the first pattern 71. That is, the sum of the height h71b of the pattern portion 71b and the height h71a of the base portion 71a may be about 40 μm or less. The height h71a of the base portion 71a may be within about 20 μm, and the height h71b of the pattern portion 71b may be in a range of 5 μm to 20 μm. In general, as the height h71b of the pattern portion 71b is greater than the width p71 of the pattern portion 71b, that is, the pattern portion 71b protrudes from the base portion 71a, the straightness of light increases, but it is practically difficult to increase the height h71b of the pattern portion 71b indefinitely in consideration of the thickness d71 of the first pattern 71. Further, when the height h71a of the base portion 71a is less than about 20 μm, considering that it is difficult to sufficiently support the pattern portion 71b, the height h71b of the pattern portion 71b may be about 20 μm or less. In addition, the height h71b of the pattern portion 71b may be 5 μm or more. When the height h71b of the pattern portion 71b is 5 μm or more, the surface area of the pattern portion 71b is secured to some extent, and thus sufficient refraction for change the path of light may occur.

The pitch p71 of the pattern portion 71b may be determined in consideration of the height h71b of the pattern portion 71b. When the ratio of pitch p71 to height h71b of the pattern portion 71b is excessively large, the surface area of the pattern portion 71b becomes small, and thus a probability of light being refracted at the surface of the pattern portion 71b is reduced. Further, when the ratio of pitch p71 to height h71b of the pattern portion 71b is excessively small, it may be difficult to ensure sufficient durability to support the pattern portion 71b protruding from the base portion 71a. Taking this into consideration, the pitch p71 of the pattern portion 71b may be in a range of 70 μm to 150 μm. That is, when the pitch p71 of the pattern portion 71b is 150 μm or less, the first pattern 71 is effective in inducing the straightness of light within the aforementioned range of the height h71b of the pattern portion 71b. Further, when the pitch p71 of the pattern portion 71b is 70 μm or more, it is advantageous to secure durability for maintaining the shape of the pattern portion 71b within the aforementioned range of the height h71b of the pattern portion 71b. In addition, in the case where the first pattern 71 is formed by an imprinting method, when a stamper is separated from a resin by the attraction force between the resin, which is the material of the first pattern 71, and the stamper, the resin may fall off. However, when the pitch p71 of the pattern portion 71b is 70 μm or more, a sufficient attractive force between the resins can be ensured to such a degree that the resin does not fall off due to the stamper. In an exemplary embodiment, the height h71b of the pattern portion 71b may about 8.5 μm, and the pitch p71 of the pattern portion 71b may be about 70 μm.

Referring to FIG. 6, the second pattern 72 may have a groove shape recessed from the surface of the first pattern 71 toward the base film BF.

In an embodiment, the plurality of second patterns 72 may be provided on the surface of the first pattern 71. These second patterns 7 may be formed to be spaced apart from each other, as shown in FIG. 4.

In an embodiment, the second pattern 72 may have a concave shape recessed from the surface of the first pattern 71.

The second pattern 72 may be a refraction pattern for refracting light to guide the light toward the display panel 300. That is, the incident angle of the light traveling in the light guide plate 10 and the optical pattern 70 through total reflection becomes smaller than a critical angle at an optical interface formed by the second pattern 72 and an air layer, so that the traveling path of the light may be changed toward the display panel 300.

The second patterns 72 may be arranged at different density along the length direction of the first pattern 71. For example, a region adjacent to the light incidence surface 10S1, to which a relatively large amount of light is guided, may has low arrangement density, and a region adjacent to the light facing surface 10S3, to which a relatively small amount of light is guided, may have high arrangement density. As another example, the area of the second pattern 72 in the region adjacent to the light incidence surface 10S1 may be made smaller, and the area of the second pattern 72 may be made larger toward the region adjacent to the light facing surface 10S3.

The second patterns 72 may be regularly arranged along the width direction of the first pattern 71, but the second patterns 72 may also be irregularly arranged. However, in order to uniformly supply light toward the display panel 300, it may be advantageous to arrange the second patterns 72 at similar density along the width direction. The second pattern 72 may be disposed not only at the ridge of the first pattern 71 but also at the valley of the first pattern 71, and may also be disposed over the ridge and the valley. In an exemplary embodiment, the second patterns 72 may be arranged to be staggered along the width direction of the first pattern 71. That is, when the length direction of the first pattern 71 is a row and the width direction of the first pattern 71 is a column, the second patterns 72 arranged in the same column may not be arranged in the adjacent row. In other words, the second patterns 72 arranged in the same column may be arranged only in the odd-numbered rows, and may not be arranged in the even-numbered rows.

In an embodiment, the second pattern 72 may be formed over two first patterns 71 or over three first patterns 71.

In other words, the width w2 of the second pattern 72 may be greater than the width w1 of the first pattern 71. Accordingly, the second pattern 72 may be formed over the adjacent two or three second patterns 71 depending on the arrangement position thereof. Although FIG. 4 and the like illustrate a case where the second pattern 72 has a circular planar shape, the present invention is not limited thereto. In another embodiment, the planar shape of the second pattern 72 may be an elliptical shape or a polygonal shape including a straight line. In this case, the width w2 of the second pattern 72 may refer to the maximum width of the planar shape.

In an embodiment, the width of the first pattern 71 may be 70 μm to 150 μm. The width of the second pattern 72 is greater than that of the first pattern 71, and may be, for example, 130 μm to 180 μm.

Referring to FIG. 6, in an embodiment, the second pattern 72 may include an upper portion 72t, a lower portion 72b, and a side wall 72s disposed between the upper portion 72t and the lower portion 72b.

The width w2 of the second pattern 72, mentioned above, may be defined as a width of the upper portion 72t.

For convenience of explanation, the height h72 of the lower portion 72b may be defined. The height h72 of the lower portion 72b may be smaller than the height h71a of the base portion 71a, described above. In other words, the lower portion 72b may be disposed closer to the base film BF than the upper end of the base portion 71a. That is, the second pattern 72 may completely penetrate the pattern portion 71b, and may be formed by digging a part of the base portion 71a. When the second pattern 72 is formed as described above, light emission efficiency can be improved.

In an embodiment, the depth d72 of the lower portion 72b may be 16 μm to 21 μm. That is, the depth of the lower portion 72b is greater than the height h71b of the pattern portion 71b, so that the second pattern 72 may completely penetrate the pattern portion 71b.

The upper portion 72t may be opened, and thus an empty space may be formed. The side wall 72s may extend from the lower portion 72b, and may connect the opened upper portion 72t and the lower portion 72b.

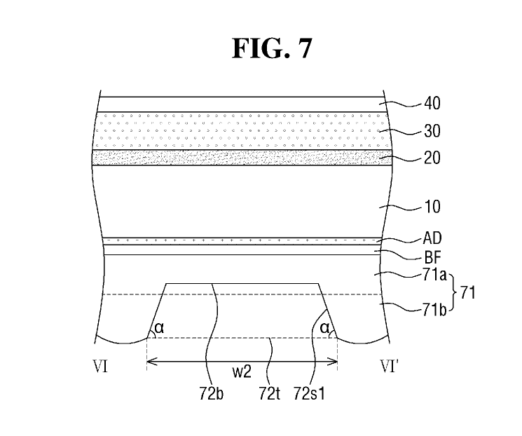

In an embodiment, the side wall 72s may extend in the vertical direction as shown in FIG. 6. However, in another embodiment, the side wall 72s may be inclined at a predetermined angle. Details thereof will be described later with reference to FIG. 7.

Hereinafter, a display device according to another embodiment of the present invention will be described. Some of the configurations described below may be substantially the same as the configurations having been described in the aforementioned display device according to the embodiment of the present invention, so that descriptions of some configurations may be omitted to avoid duplicate descriptions.

FIG. 7 is a partial cross-sectional view of a display device according to another embodiment of the present invention. Referring to FIG. 7, in an embodiment, the sidewall 72s1 may be inclined at an angle with respect to an imaginary horizontal plane.

In an embodiment, an imaginary horizontal plane (dotted line in FIG. 7) representing the side wall 72s1 and the upper portion 72t may form a first angle α. In an embodiment, the vertical horizontal plane may be a plane parallel to the lower surface 10b or upper surface 10S of the light guide plate 10 shown in FIG. 7. In an embodiment, the first angle α may be 7.5° to 55°.

In this case, the width of the second pattern 72 may decrease from the upper portion 72t toward the lower portion 72b. That is, the width of the upper portion 72t of the second pattern 72 may be greater than the width of the lower portion 72b.

Since it is difficult to place the second pattern 72 on the path of the light traveling straightly toward the light facing surface 10S3 when the first angle α is smaller than 7.5°, more light traveling paths may be guided toward the display panel 300 when the first angle α is 7.5° or more. Further, when the first angle α is greater than 55°, the incident angle of light with respect to the second pattern 72 decreases, and thus the probability of occurrence of total reflection increases, so that the traveling path of the light may be reversed toward the incident surface.

When the side wall 72s1 is inclined at the first angle α, a relatively large amount of light may be guided to travel toward the display panel 300.

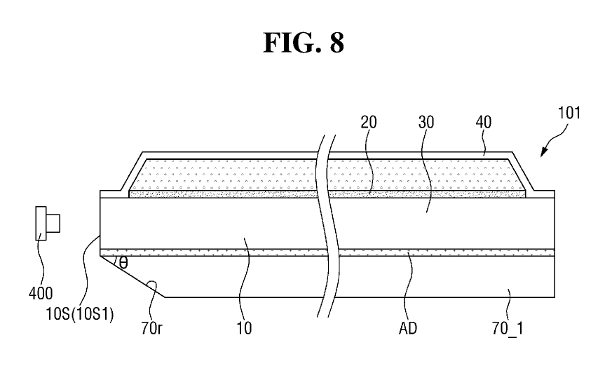

FIG. 8 is a cross-sectional view of a display device according to another embodiment of the present invention.

Referring to FIG. 8, in an embodiment, an optical pattern 70_1 may include a chamfered surface 70r.

The chamfered surface 70r may be formed at a portion of the optical pattern 70_1, the portion being adjacent to the light incidence surface 10S1.

In an embodiment, the chamfered surface 70r may form a second angle θ with the interface between the optical pattern 70_1 and the adhesive layer AD. In an embodiment, the second angle θ may be 2° to 10°.

When the chamfered surface 70r is formed adjacent to the light incidence surface 10S1, the traveling angle of light traveling toward the optical pattern may be adjusted, thereby overcoming a low refractive index difference and improving the guiding of the light.

FIG. 9 is a cross-sectional view of a display device according to an embodiment of the present invention. Referring to FIG. 9, in an embodiment, a display apparatus 1000 includes a light source 400, an optical member 100 disposed on an emission path of the light source 400, and a display panel 300 disposed over the optical member 100.

The optical member 100, may be formed using any of the aforementioned optical members.

The light source 400 is disposed near one side of the optical member 100. The light source 400 may be disposed adjacent to the light incidence surface 10S1 of the light guide plate 10 of the optical member 100. The light source 400 may include a plurality of point light sources or line light sources. The point light source may be a light emitting diode (LED) light source 410. The plurality of LED light sources 410 may be mounted on a printed circuit board 420. The LED light source 410 may emit blue light.

The blue light emitted from the LED light source 410 is incident on the light guide plate 10 of the optical member 100. The light guide plate 10 of the optical member 100 guides light and emits the light through the upper surface 10a or lower surface 10b of the light guide plate 10. The wavelength conversion layer 30 of the optical member 100 converts a part of the blue light incident from the light guide plate 10 into light of another wavelength such as green light or red light. The converted green light or red light is emitted upward together with the unconverted blue light and provided toward the display panel 300.

The optical member 100 may be coupled with the display panel 300 through an inter-module coupling member 610. The inter-module coupling member 610 may have a rectangular frame shape. The inter-module coupling member 610 may be disposed at the edges of the display panel 300 and the optical member 100, respectively.

In an embodiment, the lower surface of the inter-module coupling member 610 is disposed on the upper surface of the passivation layer 40 of the optical member 100. The inter-module coupling member 610 may be disposed on the passivation layer 40 such that its lower surface overlap only the upper surface 30a of the wavelength conversion layer 30 and does not overlap the side surface 30s of the wavelength conversion layer 30.

The inter-module coupling member 610 may include a polymer resin or an adhesive tape.

The inter-module coupling member 610 may further perform a function of blocking light transmission. For example, the inter-module coupling member 610 may contain a light absorbing material such as a black pigment or dye, or may include a reflective material.

The display device 800 may further include a housing 500. The housing 500 is open at one side, and includes a floor 510 and a side wall 520 connected to the floor 510. The light source 400, an assembly of the optical member 100 and the display panel 300, and the reflection member 250 may be accommodated in the space defined by the floor 510 and the side wall 520. The light source 400, the assembly of the optical member 100 and the display panel 300, and the reflection member 250 may be disposed on the floor 510 of the housing 500. The height of the side wall 520 of the housing 500 may be substantially the same as the height of the assembly of the optical member 100 and the display panel 300 provided in the housing 500. The display panel 300 is disposed adjacent to the upper end of the side wall of the housing 500, and they may be coupled to each other by a housing coupling member 620. The housing coupling member 620 may have a rectangular frame shape. The housing coupling member 620 may include a polymer resin or an adhesive tape.

The display device 800 may further include at least one optical film 200. One optical film 200 or a plurality of optical films 200 may be accommodated in a space surrounded by the inter-module coupling member 610 between the optical member 100 and the display panel 300. The side surfaces of the optical film 200 may be in contact with the inner side surfaces of the inter-module coupling member 610 to be attached thereto. FIG. 9 illustrates a case where the optical film 200 and the optical member are spaced apart from each other, and the optical film and the display panel are spaced apart from each other, respectively, but the spaces therebetween are not necessarily required.

The optical film 200 may be a prism film, a diffusion film, a micro-lens film, a lenticular film, a polarizing film, a reflective polarizing film, a retardation film, or the like. The display device 800 may include a plurality of optical films 200 of the same kind or different kinds. When the plurality of optical films 200 are applied, the optical films 200 may be disposed to overlap each other, and the side surfaces thereof may be in contact with the inner surfaces of the inter-module coupling member 610 to be attached thereto. The optical films 200 may be spaced apart from each other, and an air layer may be disposed between the optical films 200.

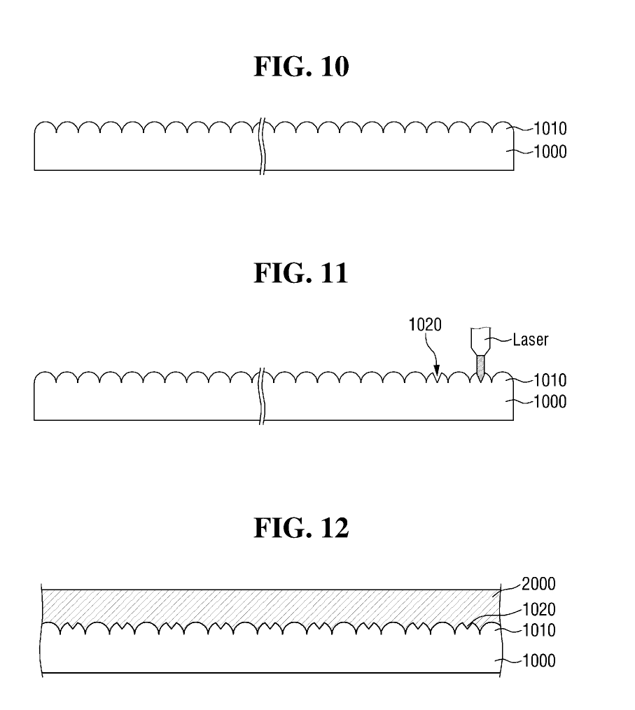

Hereinafter, a method of manufacturing a display device according to an embodiment will be described with reference to FIGS. 10 to 20.

FIGS. 10 to 20 are cross-sectional views illustrating a method of manufacturing the display device according to an embodiment of the present invention.

Referring to FIGS. 10 to 20, the method of manufacturing a display device according to an embodiment of the present invention includes a process of forming an optical pattern on a light guide plate using a stamper. First, a method of manufacturing a stamper will be described.

Referring to FIG. 10, a master substrate 1000 provided with a first master pattern 1010 having the same shape as the first pattern 71 is prepared. The master substrate 1000 may be made of PMMA (polymethyl methacrylate), PC, PET, or the like. The first master pattern 1010 may have a shape of the master substrate 1000 itself. For example, a pattern may be formed simultaneously with the extrusion of a substrate using a pattern roll (not shown). The master substrate 1000 is a hexagonal column-shaped substrate having a rectangular planar shape, and the upper surface of the master substrate 100 may be continuously engraved with the first mater pattern 1010 having a lenticular shape in one direction.

Subsequently, as shown in FIG. 11, a second master pattern 1020 is formed on the surface of the first master pattern 1010 of the master substrate 1000. The second master pattern 1020 may be formed by applying a laser. The laser may be applied according to a predetermined position. That is, the second master pattern 1020 may be predetermined to have the same arrangement as the second pattern 72. The width or depth of the second master pattern 1020 may be controlled by the wavelength, energy, irradiation time, irradiation angle, and the like of the laser. Here, the second master pattern 1020 is formed to have the same shape as the second pattern 72. That is, the second master pattern 1020 may be formed to have the same shape as the second pattern 72 having been described in the display devices according to the aforementioned embodiments of the present invention.

Further, the second master pattern 1020 may be formed by applying the laser one time, but may also be formed by applying the laser several times according to the desired shape and depth.

As a result, the master substrate 1000 may be formed to have the same master patterns 1010 and 1020 as the optical pattern 70.

Subsequently, as shown in FIG. 12, a resin is applied onto one surface of the master substrate 1000, and then cured to form a stamper 2000. Here, one surface of the master substrate 1000 refers to a surface on which the first master pattern 1010 and the second master pattern 1020 are formed.

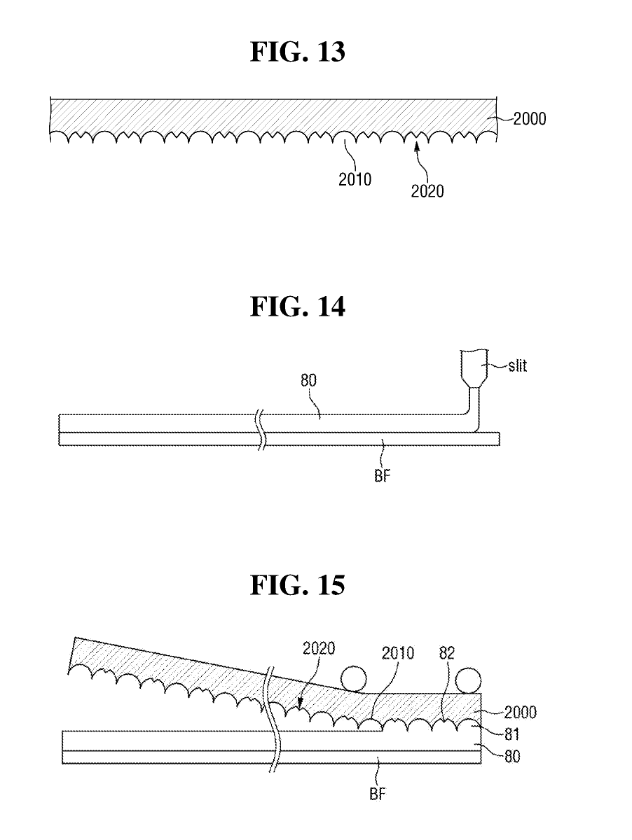

Specifically, a resin for a stamper is applied onto one surface of the master substrate 1000 using a slit nozzle. The resin for the stamper may be made of a transparent material through which ultraviolet rays can pass. Subsequently, the resin is cured by ultraviolet irradiation and/or heat irradiation, and then the cured resin is separated from the master substrate 1000 to complete the stamper 2000. The stamper 2000 is provided with patterns 2010 and 2020 having a shape opposite to that of the patterns 1010 and 1020 formed on the master substrate 1000. That is, as shown in FIG. 13, a stamper 2000 having an engraved pattern 2010 and an embossed pattern 2020 may be formed.

Subsequently, referring to FIG. 14, a resin layer 80 is applied onto a base film BF. In an embodiment, the resin layer 80 may be applied by a slit coating method. However, this is merely an example, and the application method of the resin layer 80 is not limited thereto.

In an embodiment, the resin layer 80 may be applied to a thickness of about 40 μm or less. Generally, when the resin layer 80 is UV-cured, the longer the time of exposure to ultraviolet rays, the greater the possibility that the resin layer 80 becomes yellowish. When the thickness of the resin layer 80 is 40 μm or less, the resin layer 80 may be cured without becoming yellowish. There is no limitation on the lower limit of the thickness of the resin layer 80, but it is preferable that the resin layer 80 is applied to a thickness of 20 m or more in consideration of the thickness of the optical pattern 70 to be formed later.

The resin layer 80 may be made of a material including a base resin, a UV initiator, and a binder. The base resin may include acrylate, urethane, urethane acrylate, silicone, epoxy, or a combination thereof. However, the base resin is not limited thereto as long as it is a material having a sufficient bonding force with the light guide plate 10.

Subsequently, referring to FIG. 15, the resin layer 80 is pressed by the stamper 2000 to form patterns 81 and 82. That is, when the stamper 2000 presses the resin 80 layer, the patterns 2010 and 2020 of the stamper 2000 are transferred to the resin layer 80, so that the first and second patterns 81 and 82 opposite to the patterns 2010 and 2020 in shade may be formed.

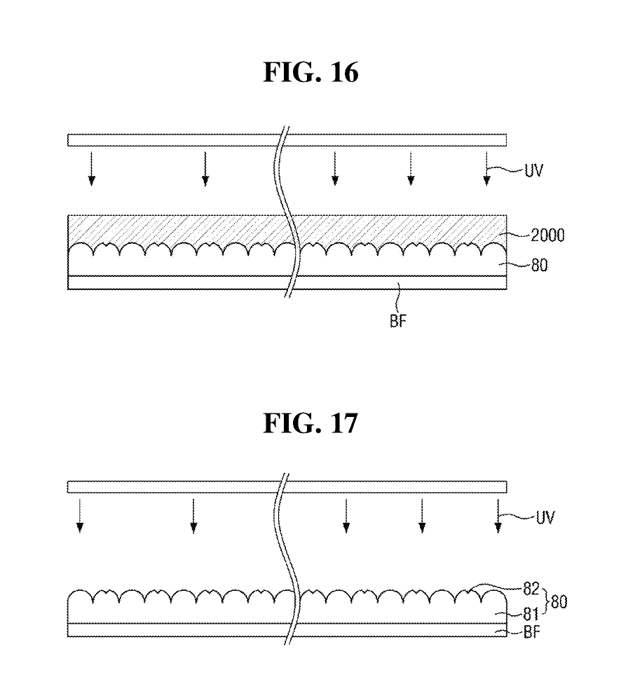

Subsequently, referring to FIG. 16, ultraviolet rays (UV) are applied onto the stamper 2000 to temporarily cure the resin layer 80. When the resin layer 80 is temporarily cured, the bonding force between the resin particles increases, so as to prevent the resin layer 80 from being detached at the time of removing the stamper 2000.

Subsequently, referring to FIG. 17, after the stamper 2000 is removed, the resin layer 80 may be finally cured. The final curing of the resin layer 80 may be performed by directly irradiating the resin layer 80 with ultraviolet rays (UV).

As a result, the resin layer 80 may have the first pattern 81 and the second pattern 82. The first pattern 81 and the second pattern 82 may be substantially the same as the first pattern 71 and the second pattern 72 described above in some embodiments of the present invention.

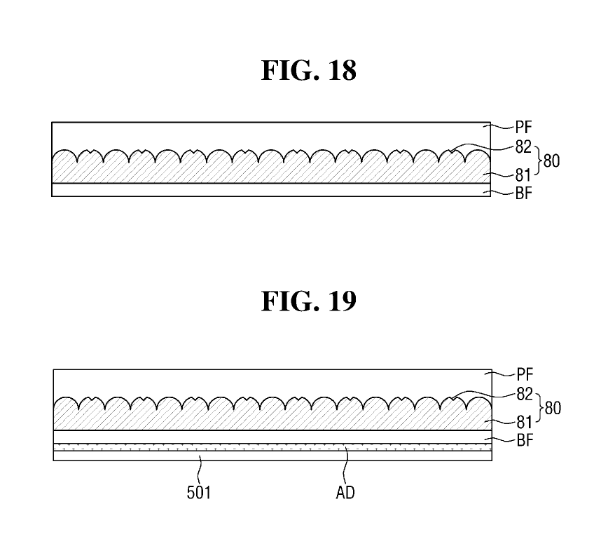

Subsequently, referring to FIG. 18, a protective film PF may be formed on the optical pattern 80. In order to prevent the optical pattern 80 from being damaged during the process, the protective film PF covering the optical pattern 80 may be disposed on the optical pattern 80.

Subsequently, referring to FIG. 19, an adhesive layer AD and a release film 501 may be formed on the lower surface of the base film BF.

In an embodiment, the adhesive layer AD may be a pressure sensitive adhesive (PSA) layer. The adhesive layer AD may be the same as that described above in the display device according to some embodiments of the present invention. Therefore, a detailed description thereof will be omitted.

In an embodiment, the adhesive layer AD may be formed by coating one surface of the base film BF.

The release film 501 may be formed on the adhesive layer AD in order to protect the adhesive layer AD and prevent foreign matter from adhering to the adhesive layer AD. The release film 501 serves to protect the adhesive layer AD before an attachment process, which will be described later, and can be easily separated from the adhesive layer AD.

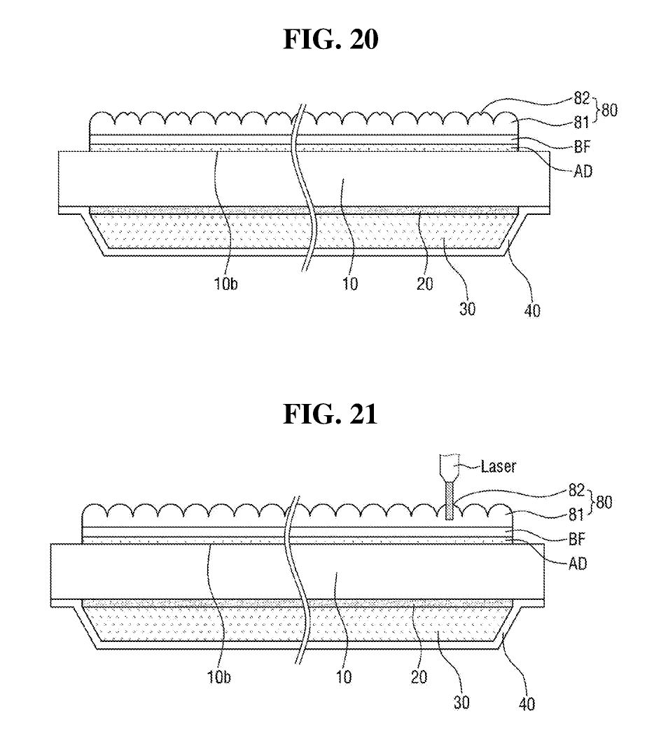

Subsequently, referring to FIG. 20, the release film 501 may be removed, and the optical pattern 80 may be attached to the light guide plate 10.

Specifically, the optical pattern 80 may be attached to the lower surface 10b of the light guide plate 10. The adhesive layer AD may be disposed between the lower surface 10b of the light guide plate 10 and the base film BF to attach the light guide plate 10b and the base film BF together.

As described above, when the optical pattern 80 and the light guide plate 10 are attached to each other using the adhesive layer AD, there is an advantage that, when defects occur in the optical pattern 80 or the light guide plate 10, these two defective components can be separated, and thus other normal components can be easily reused. That is, cost can be reduced by increasing the possibility of reuse of components.

Although it has been described in this embodiment that the adhesive layer AD is formed immediately before the optical pattern 80 is attached to the light guide plate 10, the present invention is not limited thereto.

In another embodiment, the formation of the adhesive layer AD and the release film 501 on the lower surface of the base film BF may be performed before the application of the resin layer 80 onto the base film BF.

Subsequently, the protective film may be removed. The protective film PF, which is used to protect the optical pattern 80 during the process, may be removed during the process or after the process.

FIG. 21 is a cross-sectional view illustrating a method of manufacturing a display device according to another embodiment of the present invention. Referring to FIG. 21, the formation of the second pattern 82 on the first pattern 81 may be performed after the process of FIG. 20.

Unlike the aforementioned embodiment of the present invention, the second pattern 82 may be formed after the attachment of the optical pattern 80 to the light guide plate 10.

In this case, the formation of the second master pattern 1020 in FIG. 11 is omitted, and thus, the master substrate 1000 includes only the first master pattern 1010.

Further, the stamper 2000 formed according to the master substrate 1000 may include only the engraved pattern 2010, and may not include the embossed pattern 2020.

The step of forming the second pattern 82 on the first pattern 81 may include a step of forming the second pattern 82 having a shape recessed from the upper surface of the first pattern 81 by irradiating the first pattern with a laser.

The shape of the resulting second pattern 82 may be substantially the same as the second pattern 72 described in the display device according to some embodiments of the present invention.

The embodiments of the present invention have at least the following effects.

It is possible to provide a display device having excellent light emission efficiency.

It is possible to provide a display device which is easy to reuse when defects occur.

The effects of the present invention are not limited by the foregoing, and other various effects are anticipated herein.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A display device, comprising:
a light guide plate;
a low refractive layer disposed on one surface of the light guide plate and having a lower refractive index than a refractive index of the light guide plate;
a wavelength conversion layer disposed on the low refractive layer;
an optical pattern disposed on the other surface of the light guide plate and including a base film, a first pattern disposed on the base film and having a line shape extending in one direction, and a second pattern formed on a surface of the first pattern; and
an adhesive layer disposed between the light guide plate and the base film,
wherein the adhesive layer has a refractive index equal to or greater than the refractive index of the light guide plate.

2. The display device of claim 1,
wherein the light guide plate is a glass light guide plate, and has a refractive index of 1.49 to 1.51.

3. The display device of claim 2,
wherein the adhesive layer has a refractive index of 1.49 to 1.61, and a difference in refractive index between the adhesive layer and the light guide plate is 0.1 or less.

4. The display device of claim 2,
wherein the optical pattern has a refractive index equal to or greater than the refractive index of the light guide plate.

5. The display device of claim 1,
wherein the second pattern has a shape recessed from the surface of the first pattern.

6. The display device of claim 1,
wherein the second pattern has a width greater than a width of the first pattern.

7. The display device of claim 6,
wherein the first pattern has a width of 70 μm to 150 μm, and the second pattern has a width of 130 μm to 180 μm.

8. The display device of claim 1,
wherein the first pattern includes a base portion and a pattern portion disposed on the base portion, the second pattern includes a lower portion and a side wall extending from the lower portion, and a height of the lower portion is lower than a height of the base portion.

9. The display device of claim 8,
wherein an imaginary horizontal plane parallel to one surface of the light guide plate is defined, the side wall forms a first angle with the imaginary horizontal plate, and the first angle is 7.5° to 55°.

10. The display device of claim 1,
wherein the optical pattern further includes a chamfered surface formed at a portion adjacent to one side surface of the light guide plate.

11. The display device of claim 10,
wherein the chamfered surface forms a second angle with an interface of the optical pattern and the adhesive layer, and the second angle is 1° to 10°.

12. The display device of claim 1,
wherein the low refractive layer has a refractive index of 1.2 to 1.4.

13. A method of manufacturing a display device, comprising:
preparing a light guide plate provided on one surface thereof with a low refractive layer and a wavelength conversion layer;
forming a resin layer on one surface of a base film;
pressing the resin layer using a stamper to form a pattern portion;
forming an adhesive layer on the other surface of the base film and forming a release film on the adhesive layer; and
removing the release film and attaching using the adhesive layer the base film to the light guide plate,
wherein the adhesive layer has a refractive index equal to or greater than that of the light guide plate.

14. The method of claim 13,
wherein the stamper includes an engraved pattern and an embossed pattern, and the pattern portion includes a first pattern corresponding to the engraved pattern and a second pattern corresponding to the embossed pattern.

15. The method of claim 14,
wherein the first pattern has a lenticular shape, and the second pattern has a shape recessed from a surface of the first pattern.

16. The method of claim 13,
wherein the stamper includes an engraved pattern, and the pattern portion includes a first pattern corresponding to the engraved pattern, and
wherein the method further includes: forming a second pattern on a surface of the first pattern.

17. The method of claim 16,
wherein the first pattern has a lenticular shape, and
wherein forming the second pattern on the surface of the first pattern comprises irradiating the first pattern with a laser to form the second pattern having a shape recessed from the surface of the first pattern.

18. The method of claim 13,
wherein forming an adhesive layer and forming the release film on the adhesive layer is performed before applying the resin layer on one surface of the base film.

19. The method of claim 13,
wherein the light guide plate is a glass light guide plate, and has a refractive index of 1.49 to 1.51.

20. The method of claim 13,
wherein the adhesive layer has a refractive index of 1.49 to 1.61, and a difference in refractive index between the adhesive layer and the light guide plate is 0.1 or less.
